(19) United States
(12) Patent Application Publication
(10) Pub. No.: US 2001/0020643 A1
(43) Pub. Date: Sep. 13, 2001

(54) SUBSTRATE FOR DEVICE MANUFACTURE

(76) Inventors: KEN MATSUMOTO, UTSUNOMIYA-SHI (JP); TAKASHI NAKAHARA, MACHIDA-SHI (JP)

Correspondence Address: FITZPATRICK CELLA HARPER & SCINTO, 30 ROCKEFELLER PLAZA, NEW YORK, NY, 10112, US

(21) Appl. No.: 09/134,088

(22) Filed: Aug. 14, 1998

(30) Foreign Application Priority Data
Aug. 19, 1997 (JP) 236439/1997

(51) Int. Cl. G06K 7/10

(52) U.S. Cl. 235/462.05

(57) ABSTRACT

A substrate for device manufacture, such as a photomask or a reticle, for example, is disclosed, wherein information related to the substrate is record on an end face thereof in the form of a bar code, for example.

### FIELD OF THE INVENTION AND RELATED ART

This invention relates to a substrate or plate-like article, such as a photomask, a reticle, a wafer or a glass plate, for example, for use in device manufacture. More particularly, the invention is concerned with a substrate having identification information.

Generally, semiconductor device manufacturing apparatuses use a substrate conveying system for automatically conveying a reticle, or a cassette or carrier (hereinafter “cassette”) within the apparatus or between different device manufacturing apparatuses, for prevention of adhesion of foreign particles to a substrate such as a reticle or a wafer (hereinafter, “substrate”), for example, or for improved productivity.

In such substrate conveying system, for correct selection of a desired reticle necessary for a particular production process and for quick supply of the same, and for reticle management and handling with higher reliability, a code with a pattern which bears information related to that reticle is printed on a peripheral portion of the substrate, the code being read out in each process or in each apparatus for data collection, registration, identification or confirmation.

On the other hand, due to recent tendency of multiplication of types of LSIs or complication of processes resulting from improvement in performance and reduction in size that causes increases in number of reticles required, the data volume of the code to be printed is increasing.

Also, due to recent tendency of multiplication of types of LSIs or complication of processes resulting from improvement in performance and reduction in size that causes increases in number of reticles required, higher reliability is required for reticle management and handling. A code may be printed on a reticle itself, and the code may be read out inside the apparatus and just before the reticle is used, for final identification and confirmation.

If information is to be recorded on a substrate, in order to attain enlargement of information volume of the reticle data, a large area is required for a code pattern to bear the information. However, on the reticle surface, there are a circuit pattern to be used for manufacture of semiconductor devices, as well as marks such as alignment marks to be used for different exposure processes in different exposure apparatuses. Thus, if the area of code pattern is enlarged, it will cause a difficulty in code layout design to prevent interference with marks on the reticle surface. Also, to prevent interference with marks, as an example, a code has to be divided into plural regions. This creates complexity in reading the code.

In a reticle storing system or a substrate storing shelf inside or outside an exposure apparatus, usually plural substrates are stored in accumulation along a vertical direction. Thus, the code reading when a particular substrate is to be used has to be done after the substrate is once taken out of the storing shelf.

Reticle cassettes or reticle carriers have no optical transparency, and an information code on a reticle can not be read directly. For this reason, a substitute code is printed on a cassette and, by using this substitute code, data collection or registration for the reticle stored inside the cassette is carried out. This necessitates strict control or handling to hold the one-on-one relation between a cassette and a reticle. In that occasion, when the reticle and the cassette are placed separate for cleaning of the reticle or cassette, there is a possibility of occurrence of incorrect mating of cassette reticle, which degrades reliability of reticle management and handling.

### SUMMARY OF THE INVENTION

It is accordingly an object of the present invention to provide higher reliability and efficiency in processing a substrate.

In accordance with an aspect of the present invention, there is provided a substrate for device manufacture, wherein information related to the substrate is recorded on an end face thereof.

With this arrangement, it is unnecessary to take into account the disposition of alignment marks upon a substrate surface, for example, and the whole region of the end face of the substrate can be used for the recording of substrate information. As a result, an enlargement of recording region due to an enlargement in number or type of substrates can be easily met. Further, even in an occasion where substrates are stored while being accumulated in vertical direction, information reading can be done while the substrates are kept stored. This enables flexible and multifarious control of substrates.

In a preferred form, the substrate may be a photomask or a reticle to be used in an exposure apparatus. The information may be one which can be read optically, such as a bar code, for example.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a perspective view of a reticle having a bar code provided on an end face thereof, used in a first embodiment of the present invention.

FIG. 2 is a perspective view of a reticle storing system with a bar code reading device, in a second embodiment of the present invention.

FIG. 3 is an enlarged and perspective view of a portion of the FIG. 2 structure, for explaining bar code reading.

FIG. 4 is a perspective view of a bar code reading device, in a third embodiment of the present invention.

FIG. 5 is a perspective view of a reticle storing container and a reticle bar code reading device, in a fourth embodiment of the present invention.

FIG. 6 is a perspective view of a reticle storing container and a reticle bar code reading device, in a fifth embodiment of the present invention.

FIG. 7 is a perspective view of a container for storing plural reticles therein and a reading device for reading bar codes on end faces of the reticles, in a fourth embodiment of the present invention.

FIG. 8 is a perspective view for explaining reading a bar code on an end face of a reticle stored in a cassette, in another embodiment of the present invention.

FIG. 9 is a flow chart of microdevice manufacturing processes which use a reticle of FIG. 1 or a device manufacturing method according to the present invention.

FIG. 10 is a flow chart for explaining details of a wafer process included in the procedure of FIG. 9.

### DESCRIPTION OF THE PREFERRED EMBODIMENTS

[Embodiment 1]

FIG. 1 is a schematic view of a reticle which best shows features of the present invention. Denoted at 1 is a reticle, and denoted at 31 is a bar code which is provided on an end face of the reticle. Denoted at 61 is a pattern to be printed, by exposure, on a wafer in semiconductor manufacturing procedure. The pattern occupies most of the area on the reticle surface. Denoted at 62a and 62b are alignment marks which are formed in marginal portions at left and right sides of the reticle pattern 61.

Since the bar code 31 is formed on the end face of the reticle, for a six-inch reticle, for example, an area of 6.35 mm×152 mm can be used freely for the code layout. Thus, a sufficient area can be assured for the code printing for substrate control wherein one of a large number of substrates should be discriminated. For a nine-inch reticle which is currently being standardized, a larger area can be used.

A reticle managing or controlling system using a bar code for reticle control, will be explained below.

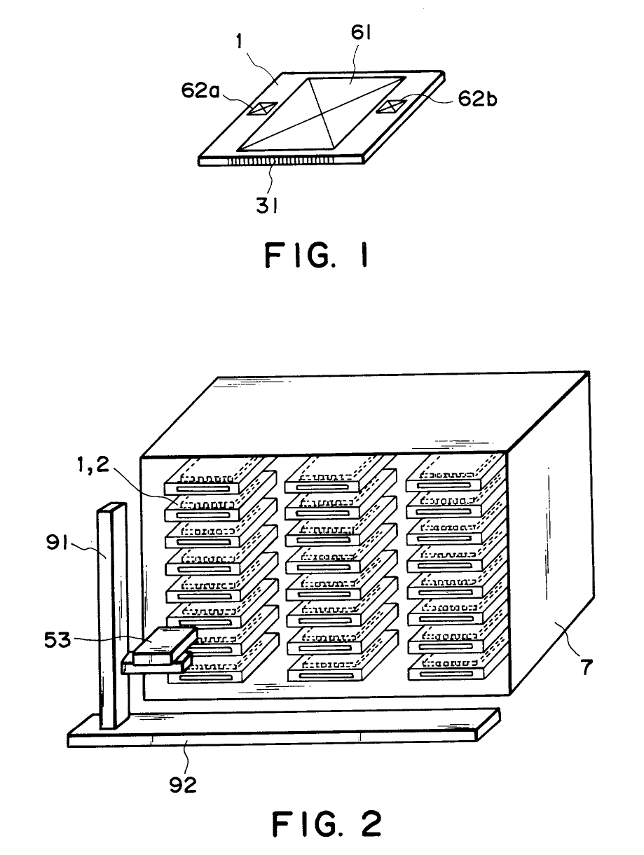

FIG. 2 shows a reticle managing system, in which denoted at 1 is a reticle, and denoted at 2 is a reticle cassette. Denoted at 53 is a bar code reading device, and denoted at 7 is a reticle storing device. Denoted at 91 is a Z slider for moving the bar code reading device upwardly and downwardly. Denoted at 92 is an X slider for moving the Z slider laterally.

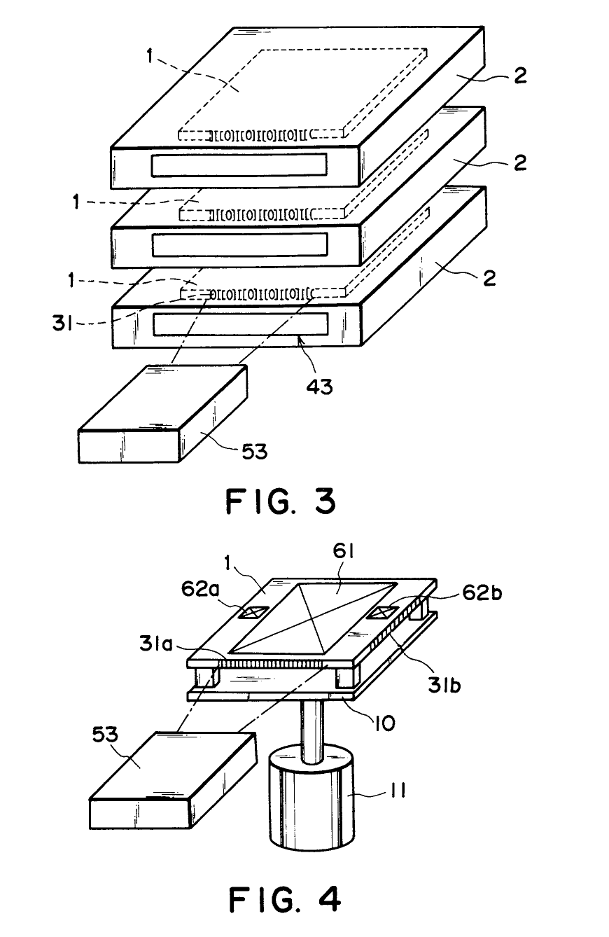

By moving the bar code reading device 53 vertically and laterally by means of the Z slider 91 and the X slider 92, a bar code of any substrate stored in the reticle storing device 7 can be read. FIG. 3 is an enlarged view for explaining bar code reading. Denoted at 31 is a bar code which is provided on an end face of a reticle. Denoted at 43 is a window which is formed on a side face of a reticle cassette and which is optically transparent. Since the bar code 31 is formed on an end face of each reticle, the bar code reading can be done while the reticles are kept stacked vertically as shown in FIG. 2 or 3.

[Embodiment 2]

FIG. 4 shows a bar code reading device for reading bar codes formed on plural end faces, in a second embodiment of the present invention. Denoted at 1 is a reticle, and denoted at 31a and 31b are bar codes formed on end faces of the reticle. Denoted at 53 is a bar code reading device, and denoted at 10 is a reticle holding table. Denoted at 11 is rotational driving means.

With the arrangement described above, the reticle 1 is held in horizontal position by the reticle holding table 10. The bar code reading device 53 is disposed at a position whereat the bar code 31a formed on an end face of the reticle can be read, and it reads the bar code. Subsequently, the rotational driving means 11 rotates the reticle holding table 10 by 90 deg., to rotate the bar code 31b position to the position whereat it can be read by the reading device 53. Then, the reading device reads the bar code. By providing codes on plural faces of a reticle, the reading device can meet a multifarious substrate control system.

[Embodiment 3]

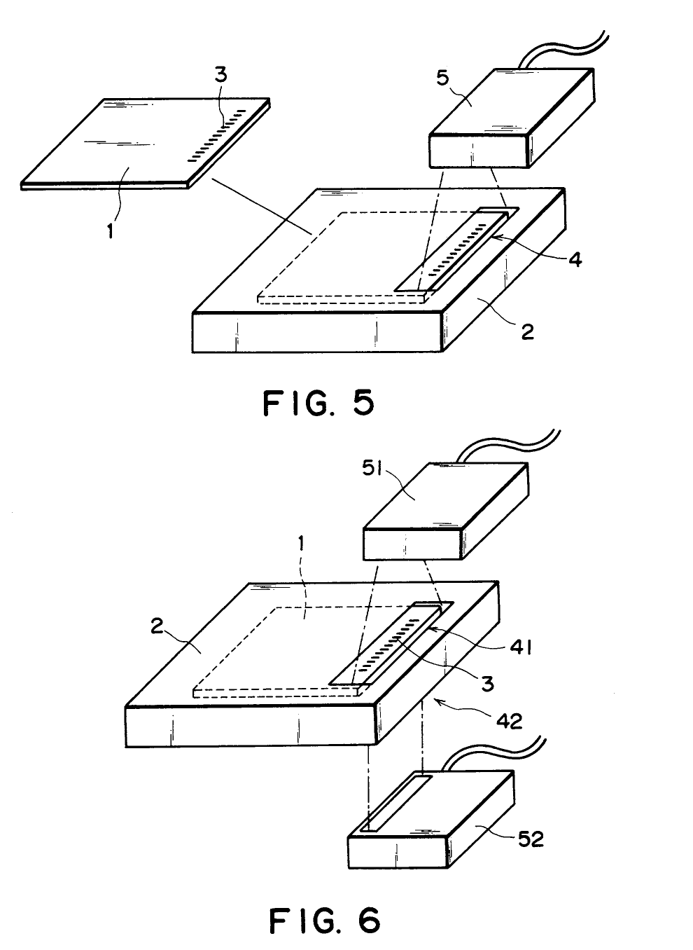

FIG. 5 shows a third embodiment of the present invention, wherein denoted at 1 is a reticle, and denoted at 2 is a reticle cassette for storing the reticle 1 therein. Denoted at 3 is a bar code which bears information related to the reticle. This bar code is provided in a circumferential portion of the reticle. Denoted at 4 is a transparent window which is provided on the cassette and which is made of an optically transparent material. Denoted at 5 is a bar code reader which includes a light projecting portion and a detecting portion disposed therewithin.

More specifically, the reticle 1 has a bottom surface on which a device pattern to be printed on a wafer for semiconductor manufacture is formed by use of Cr, for example. Outside the exposure range, a bar code 3 which bears information about the device pattern is formed similarly by use of Cr, for example. The reticle cassette 2 is provided with an optically transparent window 4 which is formed at such position that the bar code 3 can be read from the outside while the reticle 1 having the device pattern and the bar code 3 is kept stored in the reticle cassette. As for the material of the window 4, a PMMA material may be used, for example. If the weight, for example, is not limited, a glass material may be used. Also, the whole cover member of the cassette, not a portion thereof, may be made of such material.

Disposed above the cassette 2 is the bar code reader 5 which is placed at a position whereat the bar code of the reticle can be read through the transparent window 4. The bar code reader 5 has a light projecting portion for projecting light, and a detecting portion for detecting reflection light reflected from the Cr portion of the bar code 4, by which the bar code pattern can be read. The light projected to the bar code region of the reticle goes through the transparent window 4 and then it is reflected by the Cr portion of the bar code. Then, the light goes again through the transparent window 4, and it is received by the detecting portion of the bar code reader 5. It is to be noted that the total reflection factor for the reflection light (transmission factor of the transparent window plus reflection factor of Cr plus transmission factor of the transparent window) should be not less than 75%. Also, while the light projected to the glass portion of the bar code transmits therethrough, it does not transmit by 100% but a small portion is reflected at the interface between the glass and the air. The print contrast signal (PCS), which is a value representing the difference in reflection factor between the glass portion (transmissive portion) and the Cr portion (reflective portion), that is, PCS={(reflection factor of Cr portion minus reflection factor of glass portion)/(reflection factor of Cr portion)}, should desirably be not less than 0.6.

The Cr portion and glass portion can be provided in accordance with software processing, to meet any of bars and spaces of the bar code pattern.

[Embodiment 4]

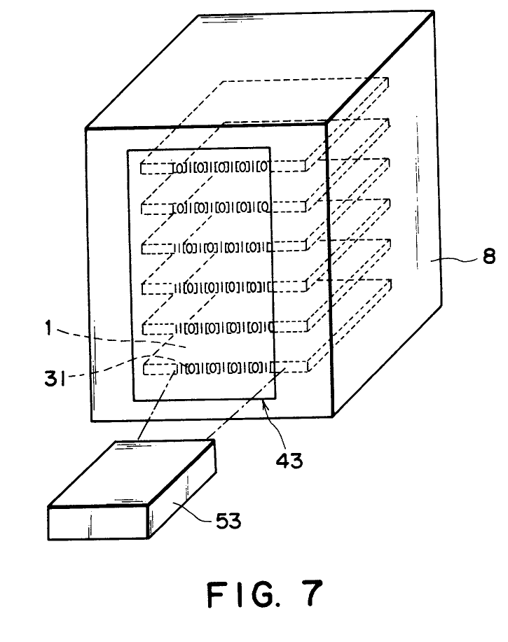

FIG. 6 shows a transmission type bar code reading device in a fourth embodiment of the present invention. A cassette 2 is provided with upper and lower transparent windows 41 and 42 which are disposed at positions where a bar code 3 formed on a reticle 2, placed inside the cassette 2, can be read. Disposed above the upper transparent window 41 is a light projecting portion 51 of the bar code reader, and disposed below the lower transparent window 42 is a detecting portion 52 of the bar code reader. They are mounted so that the light projecting portion 51 projects light which goes through the bar code 3 and is received by the detecting portion 52. In this structure, the light projecting portion and the detecting portion may be disposed inversely. Since in this embodiment the bar code pattern is formed on the bottom face of the reticle 1, the bar code reader detecting portion 52 may preferably be disposed below the reticle.

In such transmission type code reading system, the light is blocked approximately by 100% by the Cr portion of the bar code, as discussed in Japanese Laid-Open Patent Application, Laid-Open No. 66118/1995. Thus, the ratio of PCS to transmission light at the glass portion becomes approximately 1. Consequently, there is no reading error and the reading reliability is very high.

Also in this case, the total reflection factor for the transmission light (transmission factor of upper transparent window plus transmission factor of reticle glass portion plus transmission factor of lower transparent window) should be not less than 75%.

The reading method in such system is not limited to use of a bar code. It can be applied to information reading based on various patterns having reticle information, such as two-dimensional code, for example.

[Embodiment 5]

FIG. 7 shows a fifth embodiment of the present invention, wherein denoted at 1 are reticles and denoted at 31 are bar codes formed on end faces of the reticles. Denoted at 43 is a side face transmission window disposed at a position for reading the bar code 31 from the outside. Denoted at 53 is a bar code reading device disposed at a position where the bar code 31 can be read through the transparent window 43. Denoted at 8 is a reticle carrier for storing plural reticles therewithin, along a vertical direction.

In the structure described above, a bar code 31 having information related to a reticle 1 is formed on an end face of the reticle 1. Also, the side face transmission window 43 which is optically transparent is provided on the side face of the storing container. This enables reading of the bar code 31 through the bar code reading device 53 while plural reticles are kept stored and stacked in vertical direction. The bar code reading device 53 may be moved relatively upwardly and downwardly relative to the reticle carrier 8, so that it can read the bar codes of all the reticles stored in the reticle carrier 8.

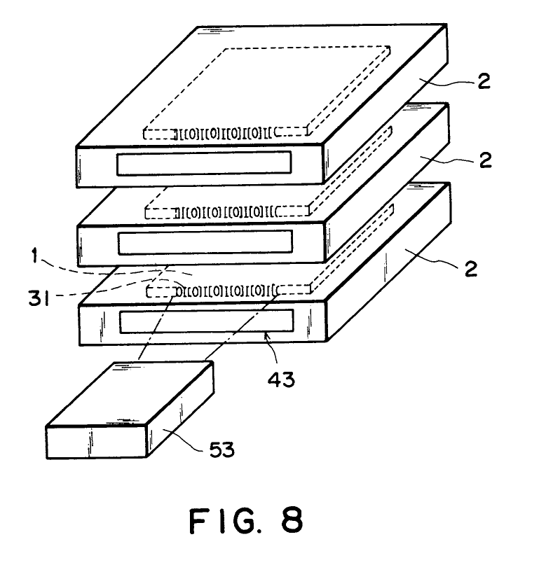

In a case where reticles are placed in reticle cassettes, respectively, and where these cassettes are accommodated while being stacked in vertical direction as shown in FIG. 8, the bar code 31 can be read by the bar code reading device 53 through a corresponding side face transmission window 43. Also, like the preceding example, the bar code reading device may be moved relatively upwardly/downwardly relative to the reticle cassettes 2, whereby a bar code of a reticle stored in any desired reticle cassette 2 can be read.

While in the embodiments described above the invention has been described with reference to examples wherein a bar code is used as a code, the code may comprise characters or any other patterns may be used and read if an OCR system or a pattern analyzer is used in the code detecting portion.

Further, the present invention is not limited to use of an optically recorded code. A magnetically recorded code and a magnetic reading device may be used.

[Embodiment 6]

Next, an embodiment of device manufacture which uses a reticle or a device manufacturing method such as described above, will be explained.

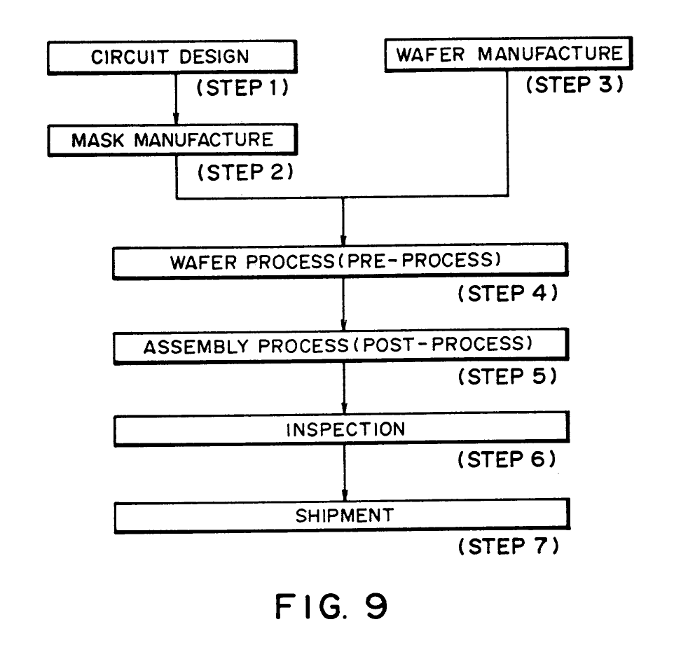

FIG. 9 is a flow chart of procedure for manufacture of microdevices such as semiconductor chips (e.g. ICs or LSIs), liquid crystal panels, CCDs, thin film magnetic heads or micro-machines, for example. Step 1 is a design process for designing a circuit of a semiconductor device. Step 2 is a process for making a mask on the basis of the circuit pattern design. Step 3 is a process for preparing a wafer by using a material such as silicon. Step 4 is a wafer process which is called a pre-process wherein, by using the so prepared mask and wafer, circuits are practically formed on the wafer through lithography. Step 5 subsequent to this is an assembling step which is called a post-process wherein the wafer having been processed by step 4 is formed into semiconductor chips. This step includes assembling (dicing and bonding) process and packaging (chip sealing) process. Step 6 is an inspection step wherein operation check, durability check and so on for the semiconductor devices provided by step 5, are carried out. With these processes, semiconductor devices are completed and they are shipped (step 7).

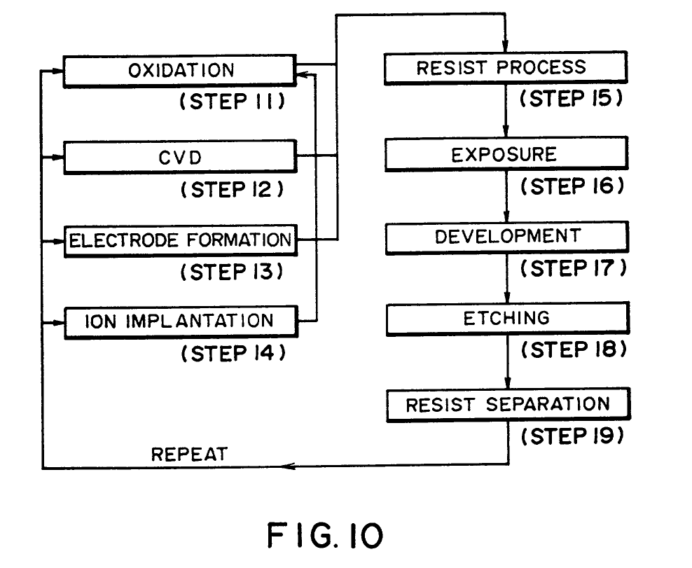

FIG. 10 is a flow chart showing details of the wafer process. Step 11 is an oxidation process for oxidizing the surface of a wafer. Step 12 is a CVD process for forming an insulating film on the wafer surface. Step 13 is an electrode forming process for forming electrodes upon the wafer by vapor deposition. Step 14 is an ion implanting process for implanting ions to the wafer. Step 15 is a resist process for applying a resist (photosensitive material) to the wafer. Step 16 is an exposure process for printing, by exposure, the circuit pattern of the mask on the wafer through the exposure apparatus described above. Step 17 is a developing process for developing the exposed wafer. Step 18 is an etching process for removing portions other than the developed resist image. Step 19 is a resist separation process for separating the resist material remaining on the wafer after being subjected to the etching process. By repeating these processes, circuit patterns are superposedly formed on the wafer.

With these processes, high density microdevices can be manufactured.

In the embodiments of the present invention having been described above, information is recorded on an end face of the substrate. This enables easy recording of information within the range of the end face and with a large information capacity. Additionally, even if plural substrates are stored in stack, information reading is easy.

Thus, in device manufacture, the efficiency and reliability of collection of information related to a substrate such as a reticle or a wafer, as well as the efficiency and reliability of control, conveyance and supply of such substrate or of a cassette or carrier having such substrate stored therein, are improved significantly. This effectively contributes to enhancement of productivity of devices such as semiconductor devices.

While the invention has been described with reference to the structures disclosed herein, it is not confined to the details set forth and this application is intended to cover such modifications or changes as may come within the purposes of the improvements or the scope of the following claims.

What is claimed is:

1. A substrate for device manufacture, characterized in that information related to a substrate is record on an end face thereof.

2. A substrate according to claim 1, wherein the substrate comprises one of a photomask and a reticle to be used in an exposure apparatus.

3. A substrate according to claim 1, wherein the information can be read optically.

4. A substrate according to claim 1, wherein the information is provided by a bar code.

5. A substrate according to claim 1, wherein the information is provided by a code for identification of the substrate among a number of substrates.
